(19) United States
(12) Patent Application Publication
(10) Pub. No.: US 2005/0076038 A1
(43) Pub. Date: Apr. 7, 2005

(54) File spacer

(76) Inventor: Helen Duke Robinson, Oneonta, AL (US)

Correspondence Address: Helen Duke Robinson, 1150 Cliff Springs Road, Oneonta, AL, 35121, US

(21) Appl. No.: 10/676,915

(22) Filed: Oct. 1, 2003

(51) Int. Cl. G06F 17/00

(52) U.S. Cl. 707/100

(57) ABSTRACT

A process for managing filing systems, comprising a File Spacer, a device used as a means for maintaining file folders in an upright position, preserving space so that new files can be inserted, and facilitating the removal and replacement of file folders which are being used. This will prevent the difficulty of removing and replacing file folders caused by overcrowding of the files. New files may be more easily inserted in the spaces preserved for them by the File Spacer. And file shelves that do not contain enough folders to support themselves can be maintained in an upright position by the File Spacer.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention is a process using file spacers, in office filing systems, for expanding and reducing the filing space as needed, while holding the files in an upright position. Open-shelf filing systems now in use contain a series of slots for inserting metal dividers to re-position the files and hold them upright. These dividers are difficult to locate and adjust when the shelf is filled with files. This invention eliminates this problem. The file spacers may also be used in file drawers.

### BRIEF SUMMARY OF THE INVENTION

The File Spacer System, a process of managing office files in open-shelf filing systems by means of File Spacers, maintains file folders in an upright position and preserves space for new files, thereby preventing overcrowding when new files are added. In open-shelf filing systems now in use, metal dividers used to keep the files upright and allow for expansion, are hard to locate and re-position when the shelves become crowded. The object of this invention is to keep the files in an orderly, upright position; to prevent overcrowding of the files; and to preserve space for additional files; making the individual files easier to locate and the file shelves easier to maintain, thereby increasing worker productivity.

### BRIEF DESCRIPTION OF THE SEVERAL VIEWS OF THE DRAWING

FIG. 1 is a perspective view of the File Spacer showing its outside configuration.

FIG. 2 is a view of the File Spacer folded for shipping or storage.
Reference 1—shows the position of the name on the File Spacer.
Reference 2—shows one of the end panels of the File Spacer.
Reference 3—shows one of the side panels of the File Spacer.
Reference 4—shows the label explaining how the File Spacer may be used.

### DETAILED DESCRIPTION OF THE INVENTION

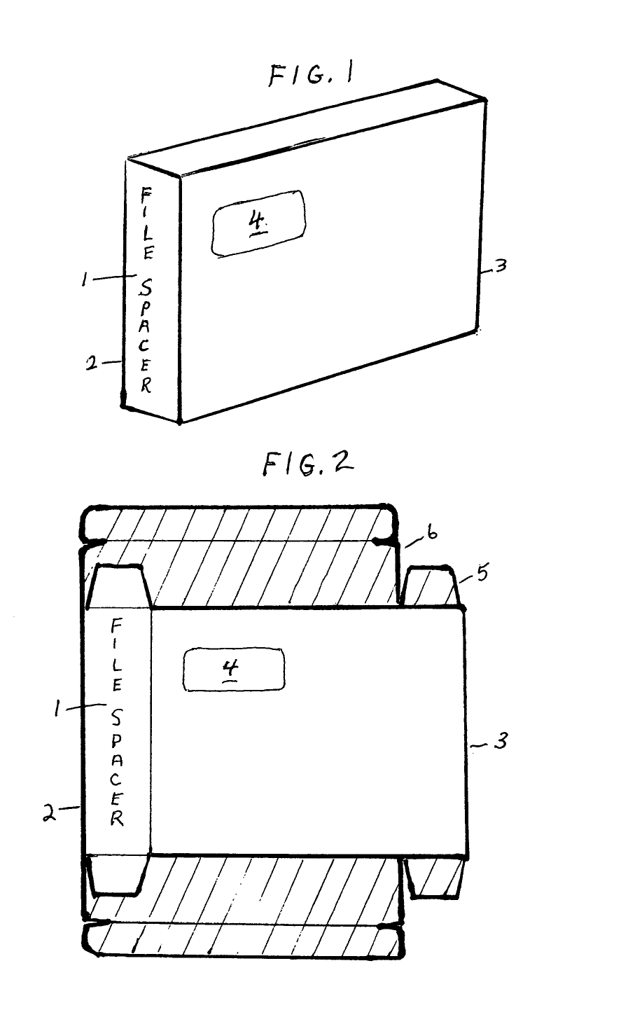

The File Spacer, shown in FIG. 1, is a three-dimensional rectangular device providing a method of using space more efficiently in an open-shelf office filing system. The invention, when placed on the shelf of the file cabinet, maintains the file folders in an upright position as individual folders are removed or replaced. It preserves space for new files and thereby prevents overcrowding when new files are added. It keeps the shelves more orderly and easy to maintain, making it easier for the worker to locate individual files.

In open-shelf filing systems now in use, metal dividers that fit into slots in the metal shelves of the filing cabinet, are used to keep the files upright and allow for expansion. These metal dividers are hard to locate and re-position when the shelves become crowded. The File Spacer solves this problem by preserving extra space for new files. The File Spacer can be moved more readily than the metal dividers since it is not attached to the shelf. Therefore, it can be re-positioned more easily to accomodate as many files as necessary. The File Spacer may be used alone or in conjunction with the metal dividers that are commonly furnished with the file cabinet.

Another advantage of the File Spacer is its versatility. It can be used in an upright position or on its side 3. Two or more File Spacers may be stacked together to assist in re-arranging a shelf full of files. One or more File Spacers may be used to fill a space where the file folders do not completely fill the space.

FIG. 2 shows one of several possible configurations of the File Spacer folded flat for shipping or storage. Keeping the File Spacer folded flat until ready to use saves storage space and shipping costs.

Reference 1 shows the name FILE SPACER on one of the end panels 2 of the invention. This comprises several possible methods for placing the name on the invention. For example, printing the name directly on the File Spacer or placing an adhesive-backed label on the File Spacer with the name printed on the label.

Reference 3, one of the side panels of the invention, includes a label 4 explaining how the File Spacer may be used. Placing the label 4 comprises several possible methods, as above in (0012). The wording on the label 4 contains an explanation such as the following:
“One or more FILE SPACERS may be used in an upright or flat position as recommended below:
   (1) To hold files in an upright position.
   (2) To leave space for a file to be returned to the shelf.
   (3) To reserve space for adding new files.
   (4) To assist in re-arranging files on the shelf.
   (5) To fill empty spaces on the shelf.
   (6) Other useful filing applications.”

The File Spacer may be constructed of various materials, in a variety of colors and sizes, but it must be sturdy and easily assembled. Referring to FIG. 2, a heavy cardboard construction, with flaps 5 to fold and flaps 6 to fold and insert into the side panel 3, forms the outside configuration FIG. 1 of the File Spacer. The size of the side panel 3 of the File Spacer is determined by the size of the folders it is intended to support, generally the file folders are letter size. The width of the end panel 2 of the File Spacer may vary but an average usable size would be two and one-half inches, more or less. The File Spacer may be any color and could comprise any decorative design on its cover.

1. The File Spacer System, a process of managing files in open shelves and other types of filing systems, comprising File Spacers as a means for preserving and maintaining space and facilitating the removal and replacement of file folders.

2. The File Spacer, as recited in claim 1, which comprises a means for:
(a) maintaining file folders in an upright position;
(b) preserving space for new files; and
(c) facilitating the removal and replacement of files which are being used.

3. A File Spacer, as recited in claim 2, which comprises a structure correlating to the length and height dimensions of letter-size and legal-size file folders, the File Spacer itself being of various widths and manufactured of various materials, and used as a means of positioning file folders in file shelves and drawers, and with the capacity for folding flat for storage.
